(19) United States
(12) Patent Application Publication
(10) Pub. No.: US 2023/0204291 A1
(43) Pub. Date: Jun. 29, 2023

(54) METHOD AND SYSTEM FOR COMPENSATING FOR ELECTRODE BURN-OFF IN AN ARC FURNANCE

(71) Applicant: Primetals Technologies Germany GmbH, Erlangen (DE)

(72) Inventors: Jürgen HUBER, Gengenbach (DE); Thierry Koeger, Hohengoeft (FR); Alexander Mueller-Mathis, Offenburg (DE)

(21) Appl. No.: 17/915,382

(22) PCT Filed: Mar. 31, 2021
(86) PCT No.: PCT/EP2021/058436

§ 371 Date: Sep. 28, 2022

(30) Foreign Application Priority Data
Mar. 31, 2020 (EP) 20167232.6

(51) Int. Cl. F27D 11/10; F27B 3/08; F27B 3/28

(52) U.S. Cl. CPC F27D 11/10; F27B 3/085; F27B 3/28

(57) ABSTRACT

A method (100) and a system (1) for compensating for an electrode (2) burn-off in an arc furnace (3) in which at least a part of the electrode (2) held in a first retaining position (H1) by a retaining device (4) is detected (Si) with the aid of a sensor device (5) and a second retaining position (H2) is determined (S2) on the basis of data generated during the detection. The retaining device (4) can then be repositioned (S4) relative to the electrode (2) from the first retaining position (H1) to the determined second retaining position (H2).

### CROSS-REFERENCE TO RELATED APPLICATIONS

The present application is a 35 U.S.C. §§ 371 national stage application of International Application No. PCT/EP2021/058436 filed Mar. 31, 2021, which claims priority to European Patent Application No. 20167232.6, filed Mar. 31, 2020, the contents of which are incorporated herein by reference.

### FIELD OF INVENTION

The present invention relates to a method and a system to compensate for the burn-off of an electrode in an electric arc furnace.

### BACKGROUND

In electric arc furnaces (EAFs), current-carrying electrodes are used in order to heat, in particular melt, melting stock, for example steel scrap. For this purpose, the melting stock is put into a vessel in which the usually vertically aligned electrodes can then be inserted at least with their lower electrode end into the melting stock.

During the melting, the electrodes are subject to wear, so-called burn-off. By the electric arcs generated between the electrodes and the melting stock, material in the region of the lower electrode ends is eroded so that the electrodes effectively become shortened during ongoing operation.

For this reason, the electrodes are usually constructed segmentally so that when required, that is to say in the event of pronounced shortening, additional electrode segments may be added at upper electrode ends, for example screwed thereto. It is furthermore necessary that the suspension of the electrodes, for example by means of a holding apparatus, is adapted in such a way that the electrodes can still be inserted at least partially into the melting stock.

WO 2014016151 A1 discloses a clamping ring device which comprises a first, upper clamping ring and a second, lower clamping ring. So that the sensitive longitudinal sections of the electrode can be detected, at least the upper clamping ring is provided with a sensor device, by means of which markings on the electrode can be detected.

WO 2017125645 presents a sliding apparatus to allow controlled displacement of the electrode. The problem is that the connecting sections of the electrode should be avoided since they are fragile, and clamping should not take place there. A detection device, which is connected to a first movement device, detects these connecting sections.

EP 3196575 A1 presents an apparatus for varying the clamping position of an electrode. A positioning apparatus, which is arranged on a fixed base and has a lifting apparatus, is used for this. The positioning apparatus can determine the position and the weight of the electrode. The positioning apparatus may also temporarily support the electrode temporarily in relation to the height position.

WO 01/88472 A1 presents a method for measuring a consumable electrode.

### SUMMARY

It is an object of the present invention to enable improved operation of electric arc furnaces, and in particular to increase the efficiency and/or reliability of such operation.

This object is achieved by a method and a system to compensate for the burn-off of an electrode in an electric arc furnace, according to the independent claims.

A method to compensate for the burn-off of an electrode in an electric arc furnace, according to a first aspect of the invention has the following steps: (i) detecting at least a part of the electrode held, in particular vertically, by a holding apparatus at a first holding position, with the aid of a sensor apparatus; (ii) determining a first distance on the basis of the data generated during the detection, the first distance being determined between an upper electrode end and the first holding position, a second holding position being determined on the basis of at least the distance and a predetermined connecting position at which two segments of the electrode are connected to one another, and a predetermined connecting region, (iii) verifying that the electrode is being supported on a supporting apparatus, and (iv) repositioning a holding apparatus relative to the electrode from the first holding position to the second holding position which has been determined.

Detection of a part of an electrode in the context of the invention is preferably (sensor-based) recording, sampling or scanning and/or the like of the electrode part. During this detection, for example, properties of the electrode and optionally also of the holding apparatus which holds the electrode, in particular its shape and/or contour, may be detected and optionally imaged, for example by (sensor) data generated during the detection.

Repositioning in the context of the invention is preferably a change in the orientation and/or location of the holding apparatus, in particular relative to an electrode. Repositioning may for example correspond to movement, in particular displacement, of the holding apparatus relative to an electrode. This may presuppose that the electrode is not held by the holding apparatus during the repositioning.

One aspect of the invention is based on the approach that a holding apparatus to hold an electrode is repositioned automatically, optionally cyclically, relative to the electrode, that is to say on automation of the repositioning. The repositioning may for example be provided or take place before or after substantial shortening of the overall length of the electrode has been established. For this purpose, at least a part of the electrode held by the holding apparatus at a first holding position is preferably detected by sensors, in order to determine a second holding position at which the holding apparatus may then be (automatically) positioned. For example, a part of the electrode may be sampled or scanned with the aid of a sensor apparatus during the detection in order to find possible new holding positions. A second holding position may then optionally be selected from them on the basis of the data thereby generated.

An upper electrode end is in this case preferably a second end of the in particular cylindrically configured electrode, which lies opposite a lower, first end of the electrode at which the burn-off occurs. The first holding position may, for example, be defined by a predetermined marking on the holding apparatus or by an element of the holding apparatus which can be detected by the sensor apparatus.

A second holding position is determined on the basis of the first distance and a predetermined connecting position at which two segments of the electrode are connected to one another. Since holding the electrode at or at least in the immediate vicinity of such a connecting position may cause damage to the electrode segments, or the segment connection, the operational reliability may be increased or at least ensured by taking the predetermined connecting position into account.

A remaining residual section, in which the electrode may be held, may be determined on the basis of the predetermined connecting position of the connecting region corresponding to the predetermined connecting position. For example, it may be established that the holding apparatus must be displaced relative to the electrode by a minimum length axially, that is to say in the direction of a longitudinal axis of the electrode, in order to avoid the electrode being held at a segment connection lying directly above the holding apparatus. In other words, it may be ensured that the second holding position does not overlap with a predetermined connecting position, or in a connecting region corresponding thereto. The connecting region may, for example, be calculated starting from the electrode end and the segments used, or detected by the sensor apparatus and/or by a special sensor apparatus.

By the sensor-based detection, for example, it may in this case be checked whether the electrode is in fact still long enough to be held in a holding position other than the current first holding position. As an alternative or in addition, it may be ensured by the sensor-based detection that the second holding position lies in a section of the electrode which is in fact suitable for the holding, and for example does not lie in the region of a connecting point of two electrode segments. Because the second holding position is preferably determined, in particular automatically, on the basis of data generated during the detection, operating errors which may occur during manual repositioning can also be at least substantially prevented.

For repositioning with the aid of the holding apparatus, for example, the electrode may be supported on a supporting apparatus preferably configured in the manner of a table, and the holding apparatus may then be displaced relative to the supported electrode as far as the second holding position, in particular after loosening a clamping or gripping unit, for instance a clamping jaw.

Preferably, the repositioning of the holding apparatus in this case comprises not only loosening or at least partially opening the clamping or gripping unit, but also finally closing or tightening the clamping or gripping unit. As a result of the final closure or tightening, the electrode may then be held at the second position.

Preferred embodiments of the invention and refinements thereof, which may respectively be combined, unless this is explicitly ruled out, in any desired way with one another as well as with the subsequently described aspects of the invention, will be described below.

In one preferred embodiment, a first, in particular vertical, distance between an upper electrode end and a marking applied on the electrode is determined on the basis of the data generated during the detection, and the determination of the second holding position is based thereon. With the aid of the first distance which has been determined, for example, it may be assessed whether enough space to hold the electrode is still available between the marking and the upper electrode. In other words, it may be assessed whether the electrode still in fact has a sufficient residual length so that holding at a second holding position is possible.

The marking is in this case preferably configured in such a way that it can be detected, in particular optically, by the sensor apparatus. The marking may for example be configured as a painted mark, one or more notches or the like. It is also conceivable for the marking to be formed by a component, for example a collar, which is fastened on the electrode in order to determine the second holding position. In this way, a user may influence the determination of the second holding position.

The marking may in this case also be formed by the holding apparatus which holds the electrode at the first holding position. Since the location of the holding apparatus relative to the electrode initially corresponds to the first holding position, in this preferred embodiment the first, in particular vertical, distance between the upper electrode end and the first holding position is determined on the basis of the data generated during the detection, and the determination of the second holding position is based thereon. For example, a second holding position which lies between the first (current) holding position and the upper electrode end may thus reliably be selected.

In another preferred embodiment, the data generated during the detection contain a profile of a horizontal distance between the electrode and/or the holding apparatus on the one hand, and the sensor apparatus on the other hand, which may also be referred to as a distance profile. Preferably, the second holding position is determined on the basis of this distance profile. In particular the first, in particular vertical, distance between the upper electrode end and the first holding position may be derived from the distance profile, and the determination of the second holding position may then be based thereon. The spatial location of the first holding position relative to the upper electrode end may be determined particularly easily with the aid of the distance profile.

The distance profile in this case preferably images the axial course of the surface, that is to say extending parallel to a longitudinal axis of the electrode, of the electrode from the upper electrode end in the direction of the first holding position. In other words, the distance profile may at least partially image a silhouette or contour of the electrode and preferably also of at least a part of the holding apparatus.

If the horizontal distance is for example detected beyond the upper electrode end, at the upper electrode end the distance profile shows for example an abrupt and significant increase in the measured horizontal distance from the sensor apparatus. A decrease in the measured horizontal distance, on the other hand, occurs for example in the region of the first holding position, where the electrode is held by the holding apparatus. These “edges” in the distance profile may form points of reference for the location of the upper electrode end and of the first holding position.

In another preferred embodiment, a pressure signal or an optical sensor device is used to verify that the electrode is being supported on a supporting apparatus, in particular configured in the manner of a table, before the holding apparatus is repositioned from the first holding position to the second holding position. In this way, in particular, it may be ensured that active repositioning of the holding apparatus is possible without risk. The optical sensor apparatus may for example be a camera, a laser sensor, a photoelectric barrier or a sensor apparatus.

For this purpose, the holding apparatus, in particular a lifting unit of the holding apparatus, may have a pressure sensor assembly to detect a pressure, in particular a hydraulic pressure, which is adapted to output the pressure signal. A hydraulic pressure is in this case to be understood as the pressure in a hydraulic medium of a hydraulic assembly which is adapted to position the holding apparatus, in particular to lift and lower the clamping or gripping unit of the holding apparatus. When the electrode is being supported on the supporting apparatus, the weight to be carried by the hydraulic assembly is reduced, so that the hydraulic pressure is reduced. This pressure decrease may be detected by the pressure sensor assembly and a pressure signal corresponding thereto may accordingly be output.

For example, the electrode may be positioned above the supporting apparatus with the aid of the holding device and then lowered until the lower electrode end makes contact with the supporting apparatus and the pressure sensor assembly therefore generates a pressure signal. As an alternative, the electrode may be positioned above the supporting apparatus with the aid of the holding device and the supporting apparatus may then be lifted until the lower electrode end makes contact with the supporting apparatus and the pressure sensor assembly therefore generates a pressure signal.

In another preferred embodiment, a residual length of the electrode is determined on the basis of the data generated during the detection, in particular on the basis of the first, in particular vertical, distance which has been determined between the upper electrode end and the first holding position, and is output. A residual length may in this case be understood as the total remaining length of the electrode. In this way, for example, it is possible to establish when it is necessary to fit a further electrode segment in order to ensure continuous operation of the electric arc furnace. In particular, in this way it is possible to estimate reliably how often repositioning of the holding apparatus relative to the electrode is still possible before a further electrode segment must be fitted.

In another preferred embodiment, the residual length is determined on the basis of a second, in particular vertical, distance between the first holding position and the supporting apparatus. For this purpose, both the holding apparatus and the supporting apparatus may have a position encoder with which a vertical distance of the holding apparatus, in particular of the gripping unit, or of the supporting apparatus can be determined with respect to a reference position, for example a floor. The difference of these vertical distances from a reference position then gives the second distance between the first holding position and the supporting apparatus. The first distance between the upper electrode end and the first holding apparatus may be added to this second distance, so that the remaining residual length of the electrode is obtained. The residual length of the electrode may therefore be determined particularly precisely.

In another preferred embodiment, the residual length which has been determined is checked after each melting cycle in the electric arc furnace and the second holding position is determined as a function of a result of the check. In this case, in particular, it is possible to check whether the residual length which has been determined reaches or falls below a predetermined minimum length threshold value. Before the second holding position is determined, is therefore possible to decide, for example, whether for example it is necessary to fit a further electrode segment onto the upper electrode end. Optionally, the new electrode length resulting therefrom may be taken into account when determining the second holding position.

In another preferred embodiment, the electrode is displaced vertically, that is to say in a direction parallel to its longitudinal axis, with the aid of the holding apparatus in order to detect at least a part of the electrode. In particular, the electrode may be displaced relative to the sensor apparatus with the aid of the holding apparatus. This allows static mounting of the sensor apparatus and therefore the omission of a separate lifting device for the sensor apparatus.

The displacement of the electrode in this case allows particularly precise detection of the horizontal distance between the electrode and the sensor apparatus. The distance profile may therefore be generated during the displacement of the electrode relative to the sensor apparatus.

In another preferred embodiment, the sensor apparatus is displaced vertically, that is to say in a direction parallel to the longitudinal axis of the electrode, with the aid of the holding apparatus in order to detect at least a part of the electrode. For this purpose, the supporting apparatus may have a lifting device. In this way, at least a part of the electrode may be detected while the electrode is being supported on the supporting apparatus. This allows a further increase in operational reliability.

In another preferred embodiment, at least a part of the electrode is detected several times in succession and the second holding position is determined on the basis of averaging the data thereby respectively generated. In particular, the second holding position may be determined on the basis of an averaged distance profile. If the sensor apparatus is for example configured as a laser scanner or has a tilting means for tilting a laser beam, at least a part of the electrode may be detected from 2 to 16 times, preferably from 4 to 12 times, in particular substantially 8 times. This makes it possible to reduce the influence of noise or of individually occurring artefacts in the data generated during the detection. The second holding position may therefore be determined particularly reliably and precisely.

In another preferred embodiment, a measure of the reliability of the data generated during the detection is determined during the detection of at least a part of the electrode. For example, on the basis of an intensity, detected with the aid of an optical sensor apparatus, of a sensor signal, for instance a laser beam, it is possible to estimate how high an aerosol concentration, for example of the dust and/or the water content, in the air is. If the measure of the reliability reaches or falls below a predetermined reliability threshold value, the detection process may be suspended and/or a corresponding warning signal may be output.

In another preferred embodiment, the sensor apparatus has a camera or a laser sensor, with which at least a part of the electrode is detected. With the aid of the camera, for example, an individual image or an image sequence of at least a part of the electrode may be recorded and, for example, the first distance between the upper electrode end and the first holding position may be determined from the image or the image sequence, for instance with the aid of an algorithm for digital image processing, in particular for feature recognition. Data generated with the aid of the laser sensor may, on the other hand, characterize a horizontal distance. For example, by moving the laser sensor relative to the electrode or the holding apparatus, a course of the horizontal distance between the electrode and the laser sensor along the longitudinal direction of the electrode, that is to say the distance profile, may thus be determined, and the first distance between the upper electrode end and the first holding position may in turn be derived therefrom. While the camera may optionally also be used for other tasks, for instance for documenting operation, for user assistance, in particular when charging the electric arc furnace, when positioning the electrode and/or the like, and therefore represents a particularly flexible or efficient solution, the laser sensor can deliver particularly precise results and is furthermore less sensitive to contamination.

In another preferred embodiment, a number of a plurality of electrodes are held with the aid of the holding apparatus. Preferably, the sensor apparatus has a corresponding number of laser sensors with which at least a part of one of the electrodes is respectively detected. In other words, one laser sensor, which is for example aligned with the respective electrode, may be provided per electrode. In this way at least a part of each electrode may be detected particularly precisely.

As an alternative, it is also possible to provide only one laser sensor, which is for example mounted tiltably or linearly displaceably and can therefore be aligned with the plurality of electrodes. In this way, it is possible to save on components and the plant complexity can be reduced.

A system to compensate for the burn-off of an electrode in an electric arc furnace has, according to a second aspect of the invention: (i) a holding apparatus, which is adapted to hold an electrode at a first holding position, in particular vertically; (ii) a sensor apparatus, which is adapted to detect a part of the held electrode at least in a region from an upper electrode end as far as the first holding position; (iii) a processing apparatus, which is adapted to verify that the electrode is being supported on a supporting apparatus, the processing apparatus furthermore being adapted to determine a second holding position on the basis of the data generated during the detection, at least the upper electrode end and the first holding position being contained in the generated data, and of a predetermined connecting position at which two segments of the electrode are connected to one another, as well as of a predetermined connecting region; and (iv) a control apparatus, which is adapted to induce repositioning of the holding apparatus relative to the electrode from the first holding position to the second holding position which has been determined.

According to a preferred embodiment, a number of a plurality of electrodes are held with the aid of the holding apparatus, and the sensor apparatus has a corresponding number of laser sensors and/or cameras, with which at least a part of one of the electrodes is respectively detected.

According to one expedient embodiment, the sensor apparatus has a camera or a laser sensor.

According to one advantageous embodiment, the processing apparatus is adapted to verify with the aid of a signal of a pressure measuring apparatus or by data of an optical sensor device that the electrode is being supported on the supporting apparatus, before the holding apparatus is repositioned from the first holding position to the second holding position.

### BRIEF DESCRIPTION OF THE FIGURES

At least partially schematically:

FIG. 1 shows an example of a system to compensate for the burn-off of three electrodes in an electric arc furnace in a plan view;

FIG. 2 shows an example of a system to compensate for the burn-off of an electrode in an electric arc furnace in a side view;

FIG. 3 shows an example of a profile of the horizontal distance between an electrode and a sensor apparatus; and

FIG. 4 shows an example of a method to compensate for the burn-off of an electrode in an electric arc furnace.

### DETAILED DESCRIPTION

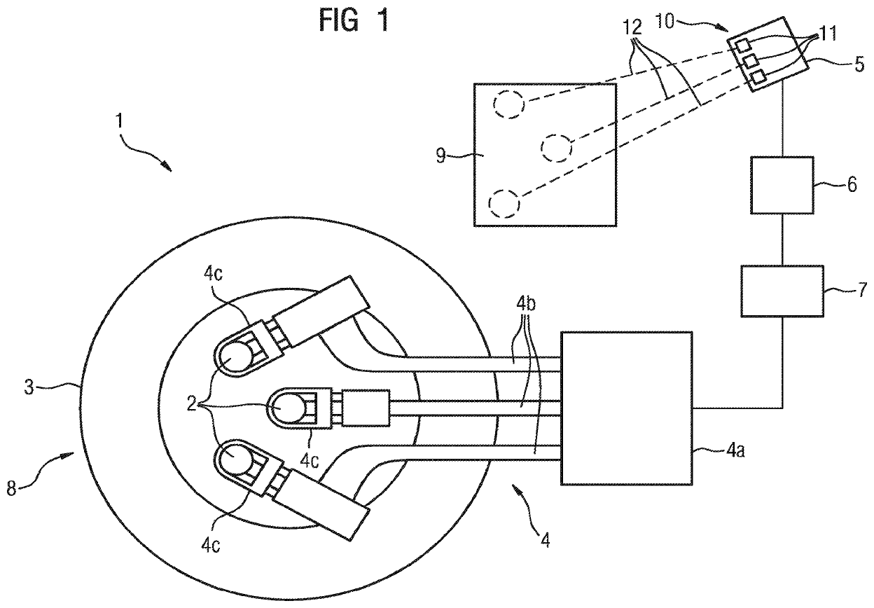

FIG. 1 shows an example of a system 1 to compensate for the burn-off of three electrodes 2 in an electric arc furnace 3 in a plan view. The electrodes 2 are respectively held by a holding apparatus 4 of the system 1, preferably vertically as represented in FIG. 1, in a first holding position. Vertical holding is in this case intended to mean holding in which a longitudinal axis of each electrode 2 is aligned vertically.

Besides the holding apparatus 4, the system 1 also has a supporting apparatus 5, which is adapted respectively to detect at least a part of the electrodes 2 being held, as well as a processing apparatus 6 which is adapted to determine a second holding position on the basis of the data generated during the detection, in particular for each of the electrodes 2. A control apparatus 7 of the system 1 is adapted to induce repositioning of the holding apparatus 4 relative to the electrodes 2 from the first holding position to the second holding position which has been determined, for example by corresponding driving of the holding apparatus 4.

With the aid of the holding apparatus 4, the vertically held electrodes 2, in particular the lower electrode ends, can be positioned in a vessel 8 of the electric arc furnace 3, where they can be inserted at least partially into a melting stock and can cause the latter to melt by flow of current. The holding apparatus 4 for this purpose has a lifting unit 4a with which the electrodes 2 can be displaced vertically, that is to say lifted and/or lowered perpendicularly with respect to the plane of the drawing.

With the aid of the holding apparatus 4, the electrodes 2 can preferably also be moved out from the vessel 8 and positioned by means of a supporting apparatus 9, which is preferably arranged externally next to the electric arc furnace 3, for example adjacent to the vessel 8. For example, carrying arms 4b of the holding apparatus 4 can be tilted horizontally, that is to say in the plane of the drawing, until the electrodes 2 are positioned over the supporting apparatus 9. From this position, indicated by dashes, the electrodes 2 may be lowered onto the supporting apparatus 9 with the aid of the lifting device 4a. As an alternative, the electrodes 2 may also be supported by lifting the supporting apparatus 9, for instance with the aid of a corresponding lifting device.

The supporting apparatus 9 and the sensor apparatus 5 are in this case preferably arranged relative to one another in such a way that the sensor apparatus 5 has a free or unobstructed field of view of the electrodes 2 supported by the supporting apparatus 9, or at least positioned above the supporting apparatus 9. A sensor apparatus 5, for example configured as a camera, may therefore reliably detect the electrodes 2 at least partially, or in sections.

In the exemplary embodiment shown, instead of a camera, the sensor apparatus 5 has a plurality of, namely three laser sensors 11, which are respectively adapted to detect, in particular to sample or scan, at least a part or section of one of the three electrodes 2 with the aid of a laser beam 12. If the sensor apparatus 5 does not have, or if the laser sensors 11 do not have, means for tilting the laser beams 12, for example in the form of tiltable mirrors, it is conceivable to provide a sensor lifting apparatus 10. With the aid of the latter, the sensor apparatus 5, or the laser sensors 11, may advantageously be displaced at least vertically in order to detect the electrodes 2 respectively from an upper electrode end at least as far as the first holding position.

As an alternative, it is however also possible that, in order to detect the regions between the upper electrode ends and the first holding positions, the electrodes 2 are displaced vertically with the aid of the holding apparatus 4, in particular the lifting unit 4a, before they are supported by the supporting apparatus 9.

Once the processing device 6 has then determined the second holding position on the basis of the data generated during the detection of the electrodes 2, the control apparatus 7 may induce the holding apparatus 4 to loosen or at least partially open clamping or gripping units 4c of the holding apparatus 4, which hold the electrodes 2, for example by gripping, so that the electrodes 2 are mobile relative to the gripping units 4c. The control apparatus 7 may then induce the holding apparatus 4, in particular the lifting unit 4a, or as an alternative the supporting apparatus 9, to be displaced vertically so that the gripping units 4c are positioned at the height of the second holding position.

Subsequently, the control apparatus 7 drives the holding apparatus 4, in particular the gripping units 4c, preferably in such a way that the gripping units 4c close again and are held firmly at the second holding position by the electrodes 2.

It is also conceivable to position the sensor apparatus 5 in such a way that the electrodes 2 can already be detected at least partially, or in sections, in particular from their upper electrode end as far as the first holding position, when the electrodes 2 are still located above the electric arc furnace 3, or the vessel 8, particularly in an operating position. In this way, the second holding position may be determined and repositioning of the holding apparatus 4, in particular of the gripping units 4c, relative to the electrodes 2 may also possibly be carried out without the electrodes 2 having to be tilted horizontally, possibly even without the electrodes 2 having to be lifted out from the electric arc furnace 3, or the vessel 8.

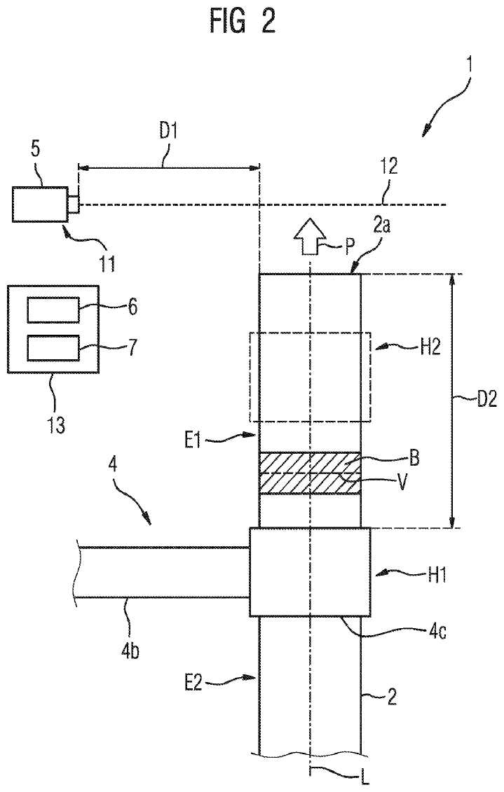

FIG. 2 shows an example of a system 1 to compensate for the burn-off of an electrode 2 in an electric arc furnace in a side view. The system 1 has a holding apparatus 4 to hold the electrode 2 at a first holding position H1 as well as a sensor apparatus 5 to detect at least a part of the electrode 2 being held. The system 1 furthermore has a processing apparatus 6 to determine a second holding position H2 on the basis of the data generated during the detection, as well as a control apparatus 7 to induce repositioning of the holding apparatus 4 relative to the electrode 2 from the first holding position H1 to the second holding position H2 which has been determined.

As represented in FIG. 2, the holding apparatus 4 in this case holds the electrode 2 vertically, that is to say in such a way that a longitudinal axis L of the electrode 2 is aligned perpendicularly.

In the example shown, the processing apparatus 6 and the control apparatus 7 are configured as software modules, which may for example be executed by a working means 13. The working means 13 may for example be a computer, in particular a personal computer, a programmable logic controller, an (application-specific) integrated circuit (ASIC) and/or the like.

The holding apparatus 4 comprises a carrying arm 4b, on the end of which facing toward the electrode 2 a gripping unit 4c, for example a clamping jaw, is arranged. With the aid of the gripping unit 4c, the electrode 2 can be gripped and held. If the gripping unit 4c loosens its grip, the holding apparatus 4 can be repositioned relative to the electrode 2, for instance by the electrode being supported statically by a supporting apparatus (not shown) at a lower electrode end (not shown) and the holding apparatus 4 being lifted.

In the example shown, the sensor apparatus 5 is configured as a laser sensor 11, which emits a laser beam 12. With the aid of the laser beam 12, the electrode 2 may be sampled, in particular from its upper electrode end 2a at least as far as the first holding position H1, or as far as the gripping unit 4c. For this purpose, the laser beam 12 may be tilted, for instance with the aid of a tiltable mirror. As an alternative, the sensor apparatus 5 and the electrode 2 may be moved relative to one another, for instance by the electrode 2 being lifted, or displaced, in the direction of the laser beam 12 with the aid of the holding apparatus 4. This is indicated by the arrow P.

The data generated during the detection with the aid of the laser sensor 11 may then contain a profile of the horizontal distance D1 between the electrode 2 and the sensor apparatus 5. For example, a first (vertical) distance D2 between the upper electrode end 2s and the first holding position H1, in particular the holding apparatus 4 or the gripping unit 4c, may be derived from this distance profile. The second holding position H2, namely between the upper electrode end 2a and the first holding position H1, may be established on the basis of the distance profile or of the first distance D2 derived therefrom.

The determination of the second holding position H2 is preferably also based on a predetermined connecting position V, at which segments E1, E2 of the electrode 2 are connected to one another, for example screwed to one another. The second holding position H2 is preferably selected in such a way that it does not overlap with the predetermined connecting position V, or a connecting region B indicated by hatching in FIG. 2 around this connecting position V, or does not fall within this connecting region B. In this way, it is possible to prevent the electrode 2, in particular a connecting means used to connect the electrode segments E1, E2, from being damaged during holding by the holding apparatus 4, for example by the exertion of a pressure with the gripping unit 4c.

FIG. 3 shows an example of a profile A of the horizontal distance D1 between an electrode held by a holding apparatus at a first holding position H1, on the one hand, and on the other hand a sensor apparatus with which at least a part, or section, of the electrode is detected, for example by displacing the sensor apparatus and the electrode or the holding apparatus relative to one another. The profile A is also referred to as a distance profile and is obtained by plotting the horizontal distance D1 against a displacement path z of the sensor apparatus and electrode, or holding apparatus, relative to one another.

The distance profile A preferably images the shape, or contour, of the electrode being held and of at least a part of the holding apparatus. In the distance profile A, for example, an upper electrode end 2a and a gripping unit 4c gripping the electrode may be seen. The location of the gripping unit 4c also gives the location of the first holding position H1 relative to the upper electrode end 2a, and therefore in particular a first (vertical) distance D2 between the upper electrode end 2a and the first holding position H1.

On the basis of the distance profile A, it is therefore possible to determine a second holding position (see FIG. 2), which preferably lies between the upper electrode end 2a and the first holding position H1. If the length of segments of which the electrode is composed is furthermore known, starting from the upper electrode end 2a it is possible to deduce predetermined connecting positions at which the segments are connected to one another. If the first distance D2 determined on the basis of the distance profile A is greater than the previously known segment length, the electrode section still available, in which the electrode may be held, may be determined by subtracting the (axial) length of a connecting region around the predetermined connecting position from the first distance D2, and the second holding position may be established on the basis thereof.

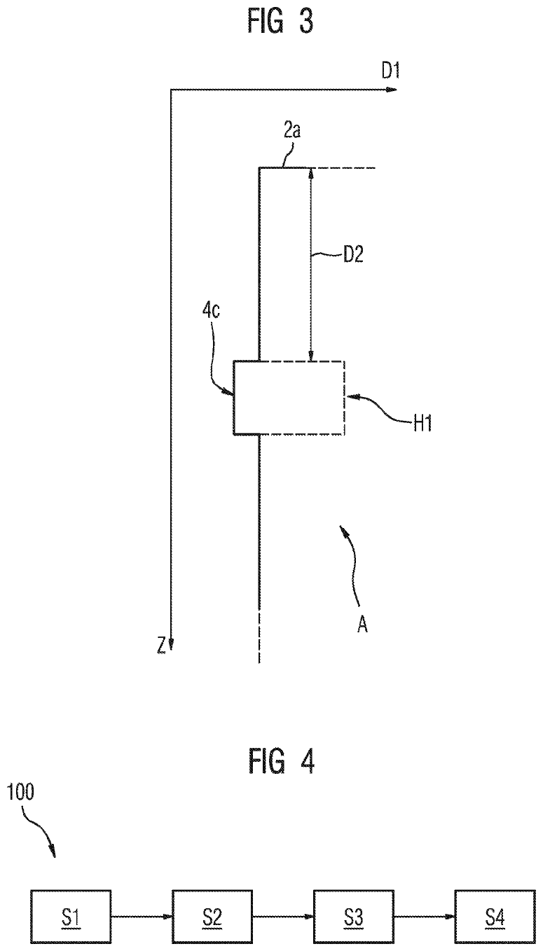

FIG. 4 shows an example of a method 100 to compensate for the burn-off of an electrode in an electric arc furnace.

In a method step S1, at least a part of the electrode held by a holding apparatus at a first holding position is detected with the aid of a sensor apparatus. For this purpose, the electrode may be sampled, or scanned, at least in sections, particularly in a region at its upper end, for example with the aid of a laser sensor.

The data thereby generated, for example a profile of a horizontal distance between the electrode and/or the holding apparatus, on the one hand, and of the sensor apparatus on the other, are used as a basis in a second method step S2 in order to determine a second holding position. For this purpose, a first, in particular vertical, distance between the upper electrode end and the holding apparatus, or the first position, may be derived on the basis of data, in particular from distance profile. This first distance determined in this way corresponds to a section of the electrode in which holding of the electrode is still possible.

Optionally, a predetermined connecting position, at which segments of electrode are connected to one another, may also be taken into account during the determination of the second holding position, in particular of the first distance. For example, an axial extent or length (“axial” referring to a direction parallel to a longitudinal axis of the electrode) of a connecting region around the connecting position may be subtracted from the first distance which has been determined, in order to obtain a “cleaned” remaining section in which holding of the electrode is possible.

In a further method step S3, the electrode may then be supported with the aid of a supporting apparatus, that is to say braced thereon. In order to verify the support, or bracing, a pressure signal may in this case be detected, which is generated for example by a pressure sensor assembly installed in the supporting apparatus or in a hydraulic assembly for lifting and lowering the supporting apparatus. From the relative positioning of the holding apparatus and the supporting apparatus which exists at the instant of the detection of the pressure signal, which may for example be detected with the aid of position encoders of the holding apparatus or of the supporting apparatus, as well as from the first distance which has been determined between the upper electrode end and the first holding position, or the holding apparatus, a remaining overall length of the electrode may then be deduced, and this may for example be output to a user.

Subsequently, in a further method step S4, the holding apparatus may be repositioned relative to the electrode, specifically in such a way that the holding apparatus then holds the electrode at the second holding position which has been determined. For this purpose, a gripping unit, for example a clamping jaw, which holds the electrode, of the holding apparatus is preferably first loosened. Subsequently, the holding apparatus and the supporting apparatus, and therefore also the electrode being supported, may be displaced relative to one another, for example by moving the holding apparatus along the electrode, that is to say parallel to the electrode longitudinal axis, or by lifting the supporting apparatus. The electrode may then be resecured, for example clamped, with the aid of the gripping unit.

### LIST OF REFERENCES

1 system
2 electrode
2a upper electrode end
3 electric arc furnace
4 holding apparatus
4a lifting unit
4b carrying arm
4c gripping unit
5 sensor apparatus
6 processing apparatus
7 control apparatus
8 vessel
9 supporting apparatus
10 sensor lifting apparatus
11 laser sensor
12 laser beam
13 working means
H1, H2 first, second holding position
D1 horizontal distance
D2 first distance
E1, E2 electrode segment
A distance profile
z displacement path
L electrode longitudinal axis
P arrow
V connecting position
B connecting region
100 method
S1-S4 method steps

1. A method to compensate for the burn-off of an electrode in an electric arc furnace, having the steps:
detecting (S1) at least an upper electrode end and a holding position (H1) of the electrode held by a holding apparatus with the aid of a sensor apparatus;
determining (S2) a first distance (D2) on the basis of the data generated during the detection, the first distance (D2) being determined between an upper electrode end and the first holding position (H1),
a second holding position (H2) is determined on the basis of at least the first distance (D2), a predetermined connecting position (V) at which two segments (E1, E2) of the electrode are connected to one another, and a predetermined connecting region (B),
verifying that the electrode is being supported on a supporting apparatus, and
repositioning (S4) the holding apparatus relative to the electrode from the first holding position (H1) to the second holding position (H2) which has been determined.

2. The method as claimed in claim 1, wherein,
a first distance (D2) between an upper electrode end and a marking applied on the electrode is determined on the basis of the data generated during the detection, and the determination of the second holding position (H2) is based thereon.

3. The method as claimed in claim 1, wherein,
the data generated during the detection contain a profile (A) of a horizontal distance (D1) between the electrode and/or the holding apparatus on the one hand, and the sensor apparatus on the other hand, and the second holding position (H2) is determined on the basis of the profile (A).

4. The method as claimed in claim 1, wherein,
a pressure signal or an optical sensor device is used to verify that the electrode is being supported on the supporting apparatus before the holding apparatus is repositioned from the first holding position (H1) to the second holding position (H2).

5. The method as claimed in claim 1, wherein,
a residual length of the electrode is determined on the basis of the data generated during the detection and is output (S3).

6. The method as claimed in claim 7, wherein,
the residual length is determined on the basis of a second distance between the first holding position (H1) and the supporting apparatus.

7. The method as claimed in claim 7, wherein,
the residual length of the electrode which has been determined is checked after each melting cycle in the electric arc furnace and the second holding position (H2) is determined as a function of a result of the check.

8. The method as claimed in claim 1, wherein,
the electrode is displaced vertically with the aid of the holding apparatus in order to detect at least a part of the electrode.

9. The method as claimed in claim 1, wherein,
the sensor apparatus is displaced vertically with the aid of a supporting apparatus in order to detect the at least one part of the electrode.

10. The method as claimed in claim 1, wherein,
at least a part of the electrode is detected several times in succession and the second holding position (H2) is determined on the basis of averaging the data thereby respectively generated.

11. The method as claimed in claim 1, wherein,
a measure of the reliability of the data generated during the detection is determined during the detection of at least a part of the electrode.

12. The method as claimed in claim 1, wherein,
the sensor apparatus has a camera or a laser sensor, with which at least a part of the electrode is detected.

13. The method as claimed in claim 1, wherein,
a number of a plurality of electrodes are held with the aid of the holding apparatus, and the sensor apparatus has a corresponding number of laser sensors with which at least a part of one of the electrodes is respectively detected.

14. A system to compensate for the burn-off of an electrode in an electric arc furnace, having:
a holding apparatus, which is adapted to hold the electrode at a first holding position (H1);
a sensor apparatus, which is adapted to detect at least a region from an upper electrode end as far as the first holding position (H1);
a processing apparatus, which is adapted to verify that the electrode is being supported on a supporting apparatus, the processing apparatus furthermore being adapted to determine a second holding position (H2) on the basis of the data generated during the detection, at least the upper electrode end and the first holding position (H1) being contained in the generated data, as well as of a predetermined connecting position (V) at which two segments (E1, E2) of the electrode are connected to one another, and of a predetermined connecting region (B); and
a control apparatus, which is adapted to induce repositioning of the holding apparatus relative to the electrode from the first holding position (H1) to the second holding position (H2) which has been determined.

15. A system to compensate for the burn-off of an electrode in an electric arc furnace as claimed in claim 14, wherein,
a number of a plurality of electrodes are held with the aid of the holding apparatus, and the sensor apparatus has a corresponding number of laser sensors and/or cameras.

16. A system to compensate for the burn-off of an electrode in an electric arc furnace as claimed in claim 14, wherein,
the sensor apparatus has a camera or a laser sensor.

17. A system to compensate for the burn-off of an electrode in an electric arc furnace as claimed in claim 14, wherein,
the processing apparatus is adapted to verify with the aid of a signal of a pressure measuring apparatus or by data of the sensor device that the electrode is being supported on the supporting apparatus, before the holding apparatus is repositioned from the first holding position (H1) to the second holding position (H2).
